(19) United States
(12) Patent Application Publication
(10) Pub. No.: US 2005/0220412 A1
(43) Pub. Date: Oct. 6, 2005

(54) Optical splitter with reflection suppression

(76) Inventors: Wen-Jiun Liu, Hsinchu (TW); Chien-Cheng Yang, Hsinchu (TW); Zhi-Cheng Hsiao, Hsinchu (TW); Shau-Yi Chen, Hsinchu (TW); Yun-Wen Lee, Hsinchu (TW)

Correspondence Address: HARNESS, DICKEY & PIERCE, P.L.C., P.O. BOX 8910, RESTON, VA, 20195, US

(21) Appl. No.: 10/901,040

(22) Filed: Jul. 29, 2004

(30) Foreign Application Priority Data
Apr. 2, 2004 (TW) 93109234

(51) Int. Cl. G02B 6/26; G02B 6/42

(52) U.S. Cl. 385/42; 385/27; 385/28; 385/31; 385/39; 385/43

(57) ABSTRACT

An optical splitter with reflection suppression is disclosed. It includes an input waveguide and a plurality of receiving waveguides. The input waveguide has at least one output surface for transferring an incident light to the receiving surfaces of the receiving waveguides. Each of the output surfaces parallels the corresponding receiving surfaces, and an oblique angle is formed between the output surface and the progressing direction of the incident light.

### BACKGROUND OF THE INVENTION

1. Field of Invention

The invention relates to an optical splitter and, in particular, to an optical splitter with reflection suppression.

2. Related Art

Due to prosperous development in information technology and rapid growth in internet uses, people have higher demands for wide bandwidths of data transmissions. Since optical fibers have such advantages of large bandwidths and low power loss, they have become the primary media in network transmissions. Thus, optical communication technology plays an important role in future information transmissions. Optical communication devices can be roughly divided into active and passive elements. The former are used to transmit/receive, amplify, and convert optical signals. Examples are lasers, optical amplifiers, wavelength converters, optical detectors, etc. The latter are used to conduct, couple, switch, split, multiplex, and demultiplex optical signals. Examples include waveguides, optical splitters, beam splitters, polarization splitters, filters, wavelength division multiplexers, optical switches, etc.

Planar lightwave circuit (PLC) technology is often used to make passive elements. Separate elements are integrated on a complete platform in order to minimize the module size, to reduce the system complexity, and to increase the device reliability and yield. In particular, the optical splitter is used to split optical energy input via one optical fiber into several optical fibers according to a predetermined proportion. It is therefore also called an optical coupler. The one-to-many structure in usual optical splitters is an input waveguide splitting into several receiving waveguides. Therefore, the optical splitting point forms a Y-branch. The receiving waveguides at the Y-branch form an acute angle. When making the optical splitters using the PLC technology, the etching depth is often not uniform enough because the line width at the acute angle is too small. In order to solve this problem, the U.S. Pat. No. 5,745,619 cuts the optical splitting point between the input waveguide and the receiving waveguides so that there are vertical cutting surfaces between the input and receiving waveguides to eliminate the subtending angle. However, when the light enters the receiving waveguide from the input waveguide, the incident light is perpendicular to the cutting surfaces of both of them. Reflections thus occur between the cutting surfaces in such as way to produce inharmonious resonance in the receiving waveguide. This will result in propagation loss in the optical flux inside the receiving waveguide.

### SUMMARY OF THE INVENTION

In view of the foregoing, the invention provides an optical splitter with reflection suppression. It cuts off the optical splitting point between the input waveguide and the receiving waveguides. The parallel surfaces of the input waveguide and the receiving waveguides are not perpendicular to the traveling direction of the incident light. This does not only solve the problem of inhomogeneous etching depths at the splitting point of the optical splitter, reflections of the incident light at the cutting surfaces can also be avoided to suppress or reduce noises during optical transmissions. Therefore, the disclosed optical splitter can be used for higher-frequency transmissions.

The disclosed optical splitter with reflection suppression is comprised of an input waveguide and a plurality of receiving waveguides. The input waveguide has at least one output surface for transmitting an incident light to the receiving surfaces of the receiving waveguides. The receiving surfaces of the receiving waveguides receive the incident light as several output beams. The output surface parallels the receiving surfaces and subtends an oblique angle with the incident light. The output surfaces may together form a single output surface or have different angles with respect to one another. The design of an oblique angle between the traveling direction of the optical beam and the cutting surfaces of the input and receiving waveguides is applied to the splitting point of the optical splitter. Such a design can simultaneously solve the problems of difficulty in etching and of noises in the optical propagation direction. The angle between the output surface and the traveling direction of the incident light has a preferred range, which according to the tilting direction can be divided into two cases. When the tilting angle is positive, the preferred range is between 70 and 90 degrees. If the tilting angle is negative, the preferred range is between −90 and −70 degrees.

Therefore, the disclosed optical splitter with reflection suppression avoids the acute angle between the waveguides at the Y-branch of the usual optical splitter. This reduces the difficulty in manufacturing and prevents noise reflections of the incident light at the cutting surfaces.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the first embodiment;

FIG. 2 is a schematic view of the second embodiment; and

FIG. 3 is a schematic view of the third embodiment.

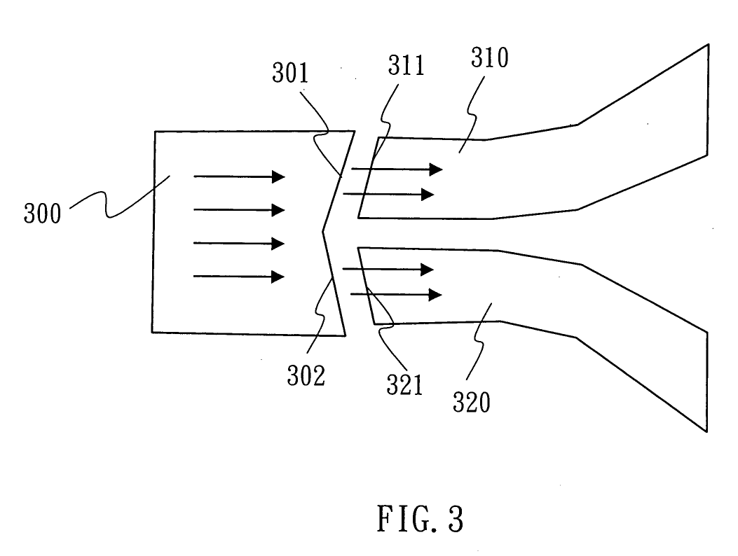

### DETAILED DESCRIPTION OF THE INVENTION

The normal planar lightwave circuit (PLC) often takes a silicon chip as its substrate, followed by the depositions of three layers of materials with different refraction indices. The top and bottom layers are covering layer. The central layer is a core layer with a higher refraction index. In a preferred embodiment of the invention, we follow the usual semiconductor process to deposit the bottom covering layer, the core layer, and the top covering layer. Afterwards, photolithography technology along with specially designed masks is employ for exposure, photolithography, and etching in order to form a slant angle for the splitting surface of the optical splitter.

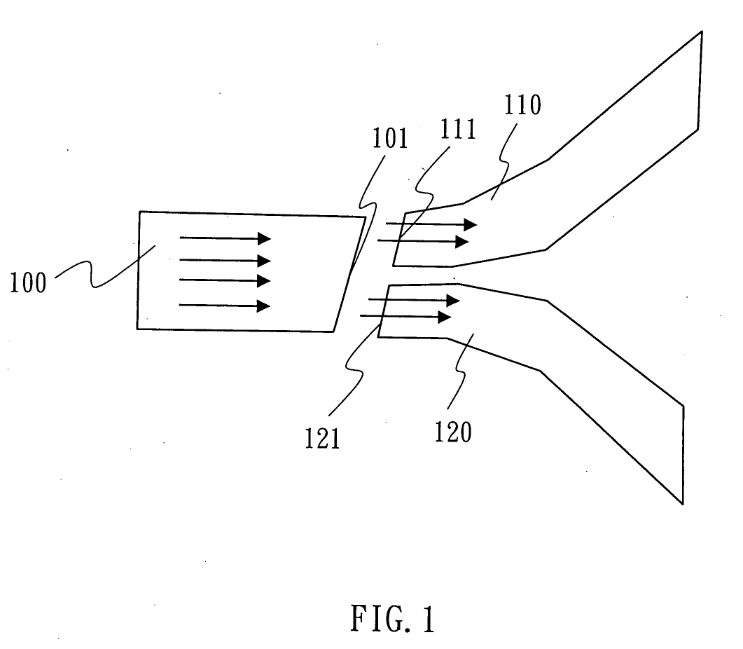

With reference to FIG. 1, the disclosed optical splitter with reflection suppression has an input waveguide 100, a first receiving waveguide 110, and a second receiving waveguide 120. The input waveguide 100 has an output surface 101 for outputting an incident light to the first receiving waveguide 110 and the second receiving waveguide 120. The first receiving waveguide 110 has a first receiving surface 111, and the second receiving waveguide 120 has a second receiving surface 121. The output surface 101 parallels to both the first receiving surface 111 and the second receiving surface 121. These surfaces have an angle about 82 degrees with respect to the traveling direction of the incident light in the input waveguide 100. The first receiving waveguide 110 and the second receiving waveguide 120 are separated by at least a gap.

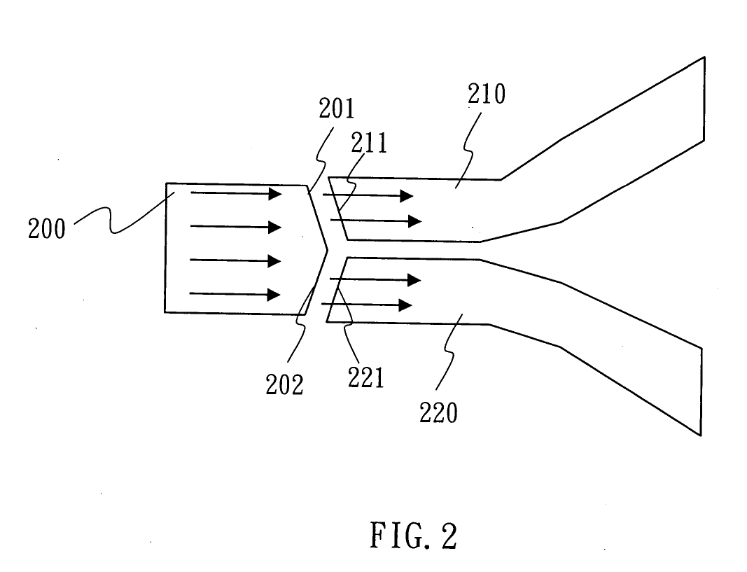

Since the output surface and the receiving surfaces are not perpendicular to the traveling direction of the incident light, the slant angle in the configuration can reduce noisy light reflections. Moreover, the input waveguide can have different output surfaces for the corresponding receiving surfaces. As shown in FIG. 2, another embodiment of the invention has an input waveguide 200, a first receiving waveguide 210 and a second receiving waveguide 220. The input waveguide 200 has a first output surface 201 and a second output surface 202 for output the incident light to the first receiving waveguide 210 and the second receiving waveguide 220. The first receiving waveguide 210 has a first receiving surface 211, and the second receiving waveguide 220 has a second receiving surface 221. The first output surface 201 parallels the first receiving surface 211, and the second output surface 202 parallels the second receiving surface 221. Thus, the incident light is output to the first and second receiving surfaces 211, 221 via the first and second output surfaces 201, 202, respectively. The first output surface 201 parallels the corresponding first receiving surface 211 and has an angle about 82 degrees with respect to the traveling direction of the incident light inside the input waveguide 200. The second output surface 202 parallels the corresponding second receiving surface 221 and has an angle about −82 degrees with respect to the traveling direction of the incident light inside the input waveguide 200. The first receiving waveguide 210 and the second receiving waveguide 220 are separated by a gap.

The structure of the invention can be formed using the semiconductor photolithograph process with appropriate masks and etching. They can also be formed using other surface machining or bulk machining methods. The input waveguide and receiving waveguides of the disclosed optical splitter can be made of P-doped silica glass, B-doped/G-doped glass/polymer or other glass/polymer with controllable refraction indices, silicon on insulator (SOI) chips, or other light conductive materials.

Certain variations would be apparent to those skilled in the art, which variations are considered within the spirit and scope of the claimed invention.

1. An optical splitter with reflection suppression, comprising:
an input waveguide, which transmits an incident beam and has an output surface, which subtends an oblique angle with respect to the traveling direction of the incident beam; and
a plurality of receiving waveguides, each of which receives the incident beam using a receiving surface parallel to the output surface, and the receiving waveguides receive the incident light as a plurality of output beams.

2. The optical splitter of claim 1, wherein adjacent two of the receiving waveguides are separated by a gap.

3. The optical splitter of claim 1, wherein the oblique angle is between 70 and 90 degrees.

4. The optical splitter of claim 1, wherein the oblique angle is 82 degree.

5. The optical splitter of claim 1, wherein the oblique angle is between −90 and −70 degrees.

6. The optical splitter of claim 1, wherein the oblique angle is −82 degree.

7. The optical splitter of claim 1, wherein the receiving surfaces and the output surface are formed using a photolithography process.

8. The optical splitter of claim 1, wherein the receiving surfaces and the output surface are formed using a surface machining process.

9. The optical splitter of claim 1, wherein the receiving surfaces and the output surface are formed using a bulk machining process.

10. The optical splitter of claim 1, wherein the input waveguide and the receiving waveguides are made of a material selected from the group consisting of P-doped silica glass, B-doped/G-doped polymer, and silicon on insulator (SOI) chips.

11. An optical splitter with reflection suppression, comprising:
an input waveguide, which transmits an incident beam and has a plurality of output surfaces, each of which subtends an oblique angle with respect to the traveling direction of the incident beam; and
a plurality of receiving waveguides, each of which receives an output beam split by the input waveguide from the incident beam using a receiving surface parallel to the associated output surface.

12. The optical splitter of claim 11, wherein adjacent two of the receiving waveguides are separated by a gap.

13. The optical splitter of claim 11, wherein each of the output surfaces has a distinct oblique angle with respect to the traveling direction of the incident beam inside the input waveguide.

14. The optical splitter of claim 11, wherein the oblique angle is between 70 and 90 degrees.

15. The optical splitter of claim 11, wherein the oblique angle is 82 degree.

16. The optical splitter of claim 11, wherein the oblique angle is between −90 and −70 degrees.

17. The optical splitter of claim 11, wherein the oblique angle is −82 degree.

18. The optical splitter of claim 11, wherein the receiving surfaces and the output surface are formed using a photolithography process.

19. The optical splitter of claim 11, wherein the receiving surfaces and the output surface are formed using a surface machining process.

20. The optical splitter of claim 11, wherein the receiving surfaces and the output surface are formed using a bulk machining process.

21. The optical splitter of claim 11, wherein the input waveguide and the receiving waveguides are made of a material selected from the group consisting of P-doped silica glass, B-doped/G-doped polymer, and silicon on insulator (SOI) chips.
